(19) United States
(12) Patent Application Publication
(10) Pub. No.: US 2018/0106161 A1
(43) Pub. Date: Apr. 19, 2018

(54) TURBINE SHROUD SEGMENT

(71) Applicant: PRATT & WHITNEY CANADA CORP., Longueuil (CA)

(72) Inventors: Remy SYNNOTT, St-Jean-sur-Richelieu (CA); Franco DI PAOLA, Montreal Nord (CA); Guy LEFEBVRE, St-Bruno-de-Montarville (CA)

(21) Appl. No.: 15/297,492

(22) Filed: Oct. 19, 2016

(51) Int. Cl. F01D 11/12; F01D 25/24; F01D 9/04

(52) U.S. Cl. CPC F01D 11/122; F01D 25/24; F01D 9/041; F05D 2220/32; F05D 2230/60; F05D 2240/30; F05D 2240/12; F05D 2240/55; F05D 2240/14

(57) ABSTRACT

A gas turbine engine has an engine case and a circumferential array of rotor blades, rotatable about a centerline. A stator vane assembly is located within the engine case and axially spaced from the array of rotor blades. The stator vane assembly is formed by a plurality of stator vane segments, disposed circumferentially one adjacent to another. Each stator vane segment has an outer endwall, a plurality of vanes extending radially from the outer endwall towards the centerline and a shroud segment extending axially from the outer endwall. The shroud segment is configured to extend to and surround the array of rotor blades. The shroud segment has an abradable portion. The vane assembly is secured relative to the engine case.

### TECHNICAL FIELD

The application relates generally to the field of gas turbine engines and, more particularly, to shrouding arrangements for surrounding the blades of gas turbine engine rotors.

### BACKGROUND OF THE ART

In gas turbine engines, rotor tip clearance is an issue that affects turbine performance. Shrouds are used to address this issue. In typical gas turbine engines, the vane ring assembly is allowed some movement in the radial direction relative to the engine case: this is desirable to account for the thermal expansion of such vane assembly during operation of the gas turbine engine. The shrouds are integrated to such vane ring assembly, for example by being secured to the vane ring; however, as the vane ring assembly moves radially during operation as a result of thermal expansion, so do the shrouds, thereby reducing their sealing effectiveness. In more recent engines, shroud assemblies are directly secured to the engine case and made to move independently of the vane assembly. As the engine case temperature is lower than that of the vane assembly, radial movement due to thermal expansion is reduced during operation, thereby improving the shroud assemblies' sealing effectiveness. Such shroud assemblies have however certain design complexities, in order to be able to both support the sealing element and be secured to the engine case. Therefore, whenever the shroud assemblies need to be replaced/overhauled, there is a significant cost associated therewith. There is therefore a continued need for alternative shroud arrangements.

### SUMMARY

In one aspect, there is provided a gas turbine engine apparatus comprising: an engine case; a circumferential array of rotor blades located within the engine case and rotatable about a centerline; and a stator vane assembly located within the engine case, and axially spaced from the array of rotor blades, said stator vane assembly comprising a plurality of stator vane segments disposed circumferentially one adjacent to another, each stator vane segment comprising: an outer endwall, a plurality of vanes extending radially from the outer endwall towards the centerline, and a shroud segment extending axially from the outer endwall configured to extend to and surround the array of rotor blades, the shroud segment including an abradable portion surrounding the rotor blades; wherein the vane assembly is secured relative to the engine case.

In another aspect, there is provided a method for sealing a rotating circumferential array of rotor blades in a gas turbine engine having an adjacent vane assembly, the method comprising: surrounding the array of rotor blades with an abradable element assembly configured to abrade when contacted by the rotor blades; securing the abradable element assembly to an outer shroud of the vane assembly; and securing the vane assembly to the engine case.

In a further aspect, there is provided a stator vane segment for use in a gas turbine engine, the stator vane segment comprising a plurality of vanes extending between an outer endwall and an inner endwall, the outer endwall extending axially to provide a shroud, the shroud including an abradable portion configured to surround a rotating array of rotor blades; wherein the stator vane segment is configured to be securable to an engine case.

Further details of these and other aspects of the subject matter of this application will be apparent from the detailed description and drawings included below.

### DESCRIPTION OF THE DRAWINGS

Reference is now made to the accompanying figures in which:

FIG. 1 is a schematic cross-sectional view of a gas turbine engine;

FIG. 2 is an isometric view of the stator vane segment pursuant to an embodiment of the invention;

FIG. 3A-3B are side sectional views of the stator vane segment pursuant to an embodiment of the invention when positioned within the engine;

FIG. 4 is a side sectional view of the stator vane segment pursuant to an alternate embodiment of the invention when positioned within the engine;

FIG. 5A is a front sectional view of stator vane segments pursuant to an embodiment of the invention when positioned within the engine; and

FIG. 5B is an isometric view of stator vane segments pursuant to an embodiment of the invention when positioned within the engine.

### DETAILED DESCRIPTION

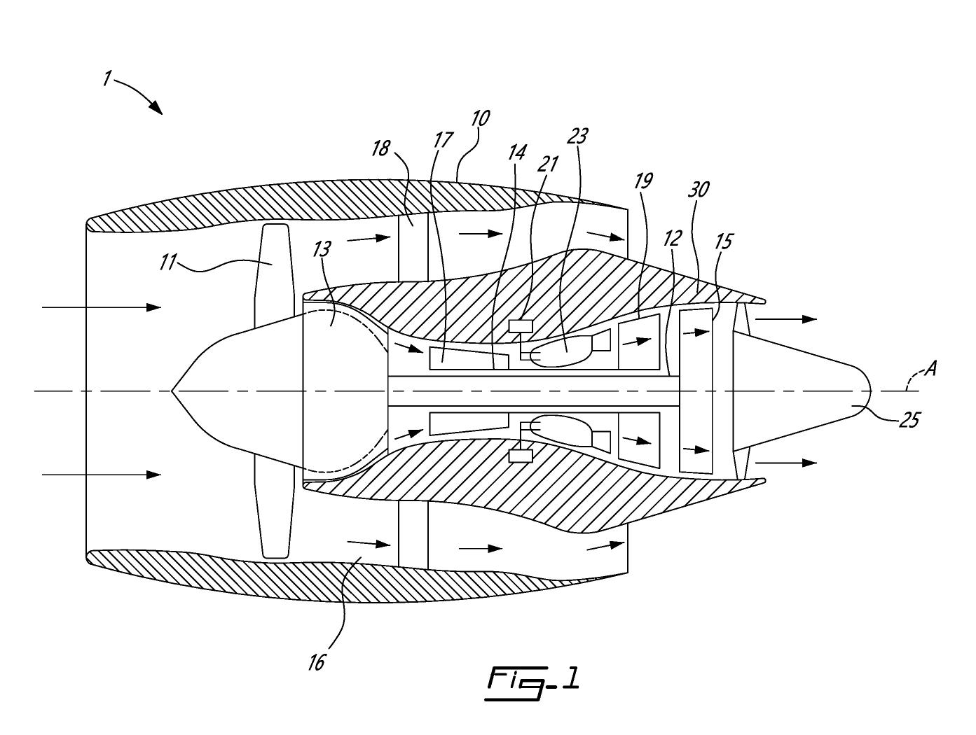

FIG. 1 illustrates an example of a turbofan gas turbine engine 1 generally comprising a housing or nacelle 10; a low pressure spool assembly 12 including a fan 11, a low pressure compressor 13 and a low pressure turbine 15; a high pressure spool assembly 14 including a high pressure compressor 17, and a high pressure turbine 19; and a combustor 23 including fuel injecting means 21. Gas engine compressors and turbines are typically assemblies of axially-alternating stators and rotors, with the stators directing the fluid flow as needed and the rotors compressing/extracting energy from (as the case may be) the gases flowing therethrough.

The engine case 30 is concentrically mounted about centerline A. Engine case 30 may, in turn, may be structurally connected to nacelle 10 through a plurality struts 18 extending radially through a bypass passage 16 of the engine. It may also be appreciated that a tail cone 25 may be positioned at an aft end of engine case 30.

In operation, hot combustion gases discharged from combustor 23 power and flow through high and low pressure turbines 19 and 15, and are then exhausted into the atmosphere.

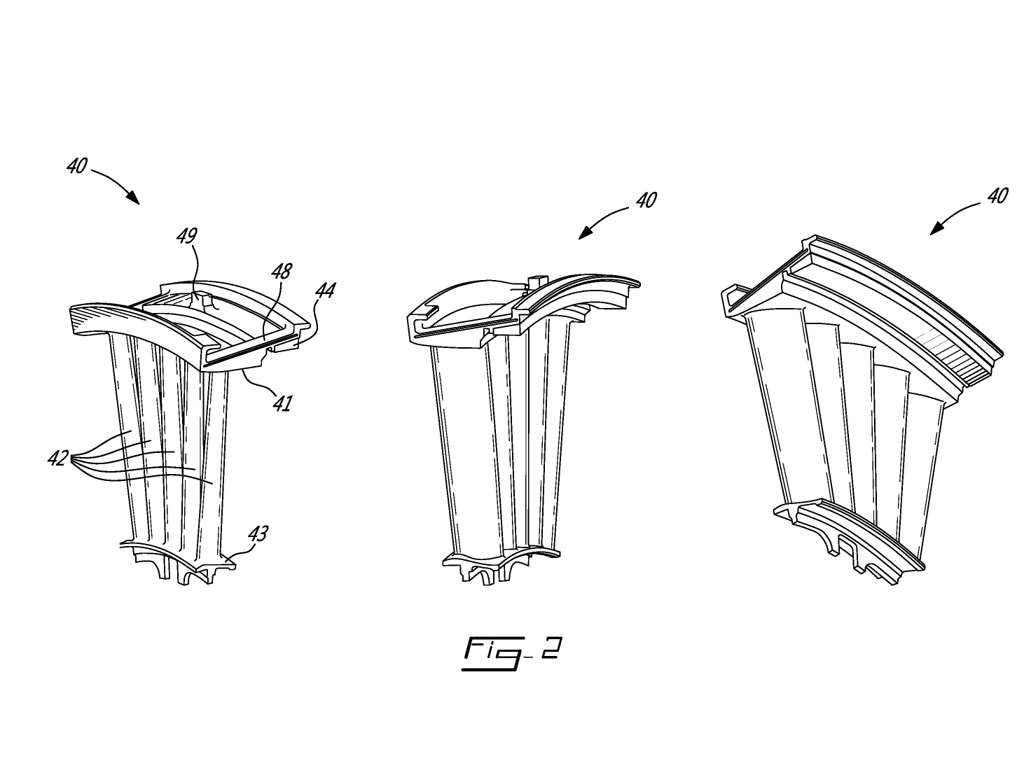

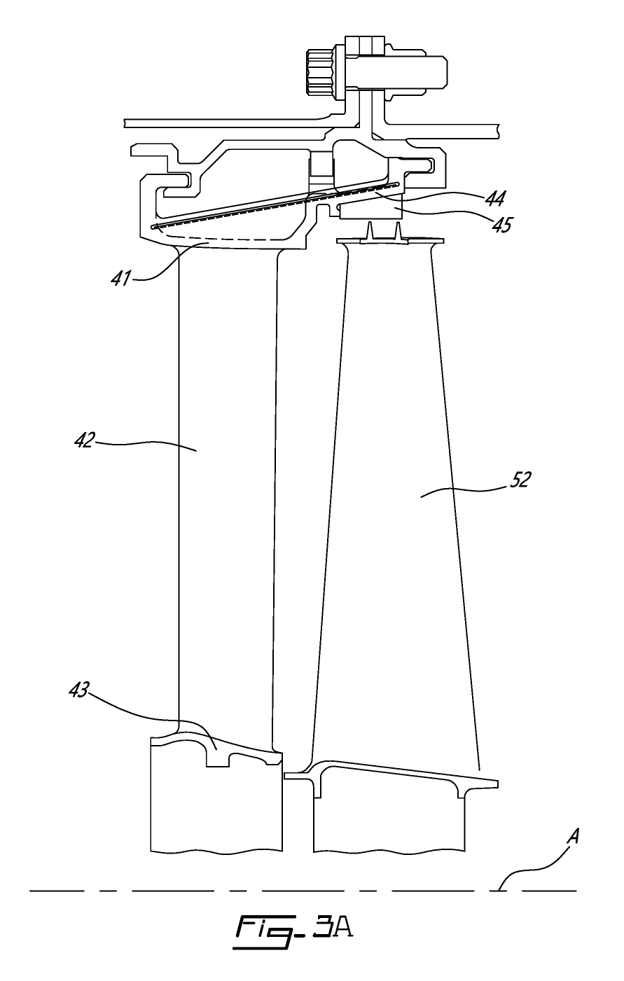

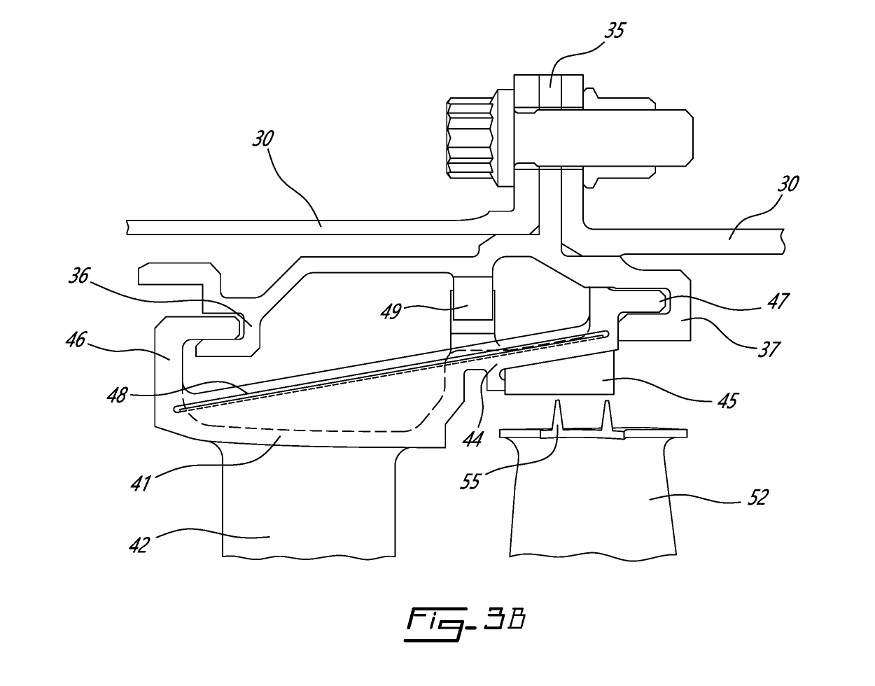

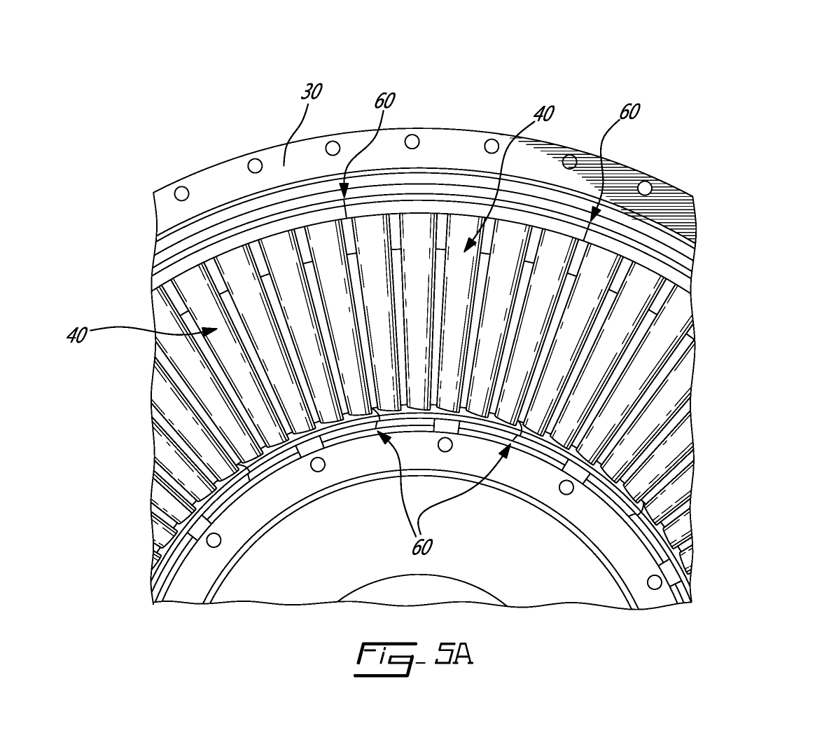

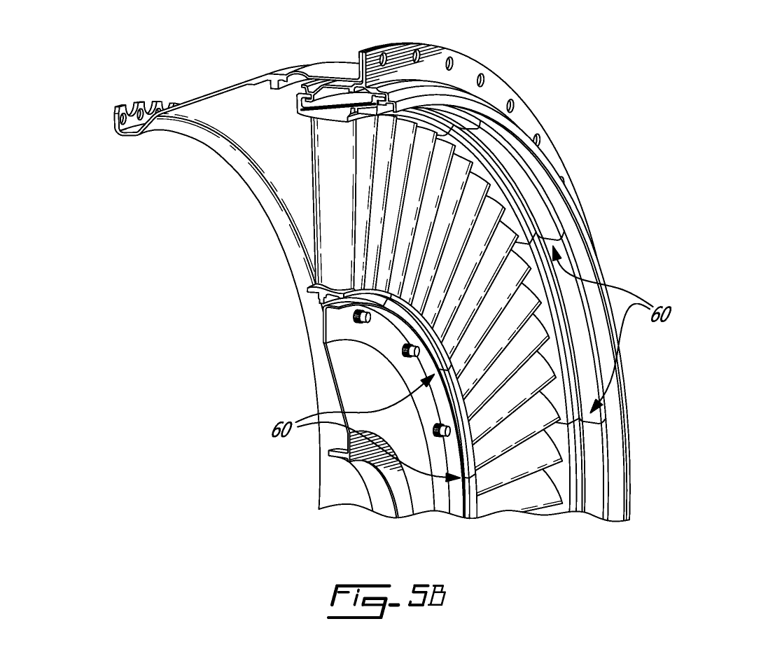

Pursuant to an embodiment of the invention, a stator vane assembly of a low pressure turbine will be described. More specifically, as shown in FIGS. 2, 3A & 3B, a stator vane segment 40 will be described, but it is understood that, when disposed circumferentially one adjacent to another, as partially shown in FIGS. 5A & 5B, stator vane segments 40 combine to form a circular stator vane assembly that is located within engine case 30 and axially spaced from a circumferential array of rotor blades 52, the rotor blades forming part of a rotor assembly. Although the present embodiment of the invention was developed for application in low pressure turbine sections, applications in other sections of the gas turbine engine are contemplated herein.

The stator vane segment 40, shown by itself in FIG. 2 and as attached to engine case 30 when in operation in FIGS. 3A-3B, comprises a plurality of vanes 42 which extend radially between an axially-extending outer endwall 41 and an axially-extending inner endwall 43. Such inner endwall 43 is secured to engine 1 in a manner that is typical and will be apparent to those skilled in the art.

Stator vane segment 40 further comprises a shroud segment 44 which is integral to and extends axially from outer endwall 41. When stator vane segment 40 is installed in a gas turbine engine, shroud segment 44 surrounds the circumferential array of rotor blades 52. Shroud segment 44 is positioned radially further away from centerline A than outer endwall 41, as it is preferable that array of rotor blades 52 extends radially further away from centerline A in relation to position of outer endwall 41.

An abradable element 45 is secured to shroud segment 44. The qualifier “abradable” is meant to signify that element 45 is made of a material that, when the gas turbine engine is in operation, wears away when array of rotor blades 52 enters in frictional contact with it, more specifically when shrouded end 55 of array of rotor blades 52 enters in frictional contact with. It is understood that in sections of the gas turbine engine where rotor blades are not or cannot be shrouded, it is the unshrouded end (or tip) of the rotor blade that will wear away abradable element 45. An example of an acceptable material for abradable element 45 is honeycomb. Abradable element 45 is also positioned radially further away from centerline A than outer endwall 41, as it is preferable that array of rotor blades 52 extends radially further away from centerline A in relation to position of outer endwall 41.

As shown in more details in FIG. 3B, each stator vane segment 40 is radially secured to engine case 30 via engine case connecting element 35. This means that shroud segment 44, and secured abradable element 45, do not move radially in relation to engine case 30. More specifically, L-shaped ends 46 and 47 of stator vane segment 40 are mounted into C-shape ends 36 and 37 of engine case connecting element 35 to prevent significant radial movement between outer endwall 41/shroud segment 44/abradable element 45 and engine case 30. As outlined above, engine case mounting, with the consequent movement restraint therebetween, is desirable as radial movement due to thermal expansion is reduced in the relevant area during operation, thereby having a positive effect on abradable element 45's sealing effectiveness.

In the embodiment shown in FIGS. 2, 3A and 3B, L-shaped end 46 of stator vane segment 40 do not extend circumferentially along the whole segment, but is localised at each segment's circumferential extremity. At each such extremity, there is also a stator vane support element 48, extending between L-shaped ends 46 and 47, to assist in the structural integrity of stator vane segment 40 as it is secured to engine case 30 (via engine case connecting element 35). Stator vane support tab 49 also assists in this respect.

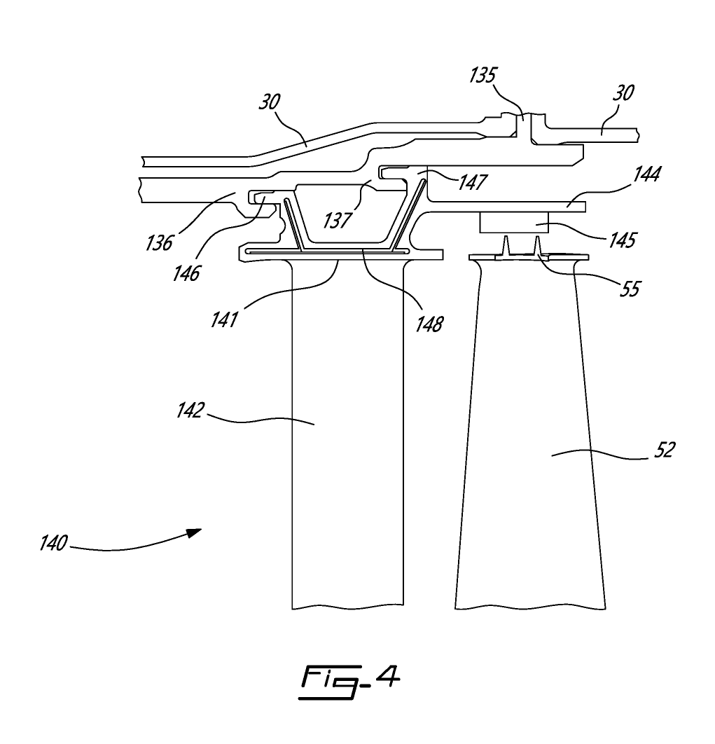

It will be understood that other techniques for radially securing each stator vane segment 40 to engine case 30 and for assisting in the structural integrity of stator vane segment 40 as it is secured to engine case 30, such as the embodiment described in more details below (and shown in FIG. 4) or such a direct coupling embodiment that does not make use of an engine case connecting element (not shown), are possible pursuant to the invention.

As discussed above and partially shown in FIGS. 5A and 5B, stator vane segments 40 combine to form a circular stator vane assembly. Each pair of circumferentially adjacent stator vane segments 40 defines an inter-segment gap 60. Such gap is dimensioned so as to permit the anticipated level of thermal expansion that such vane assembly will need during operation of the gas turbine engine. Axially-extending feather seals (not shown), or other suitable seals, may be positioned across such inter-segment gap to address any undesired level of radial gas leakage.

The anticipated level of thermal expansion that such vane assembly will need during operation of the gas turbine engine may also be addressed by ensuring that, when stator vane segments 40 are secured to engine case 30, in the embodiment shown in FIGS. 3A & 3B via engine case connecting element 35, some axial movement is possible during operation i.e. that there is some freedom of axial movement between stator vane segment 40 and engine case 30. In the embodiment shown in FIGS. 3A and 3B, this is accomplished by having L-shaped ends 46 and 47 of stator vane segment 40 mounted into C-shape ends 36 and 37 of engine case connecting element 35. Because L-shaped ends 46, 47, and C-shape ends 36, 37, are oriented in the same direction, stator vane segment 40's radially outer section, more specifically outer endwall 41/shroud segment 44/abradable element 45, have some freedom of axial movement, in the current case upstream freedom of movement (towards left hand side of FIGS. 3A & 3B). It will be understood by those skilled in the art that axially adjacent elements of the gas turbine engine will serve, to the level required, to limit such upstream freedom of movement (towards left hand side of FIGS. 3A & 3B). Such axially adjacent elements may or may not include biasing elements that will secure stator vane segments 40 to engine case 30 (via engine case connecting element 35) while still allowing the necessary anticipated movement that will arise due to thermal expansion.

As discussed above, other techniques for radially securing each stator vane segment 40 to engine case 30 and for assisting in the structural integrity of stator vane segment 40 as it is secured to engine case 30 are possible pursuant to the invention. For example, as shown in FIG. 4, stator vane segment 140 comprises a plurality of vanes 142 which extend radially between an axially-extending outer endwall 141 and an axially-extending inner endwall (not shown).

engine case connecting element 135 comprises C-shape ends 136 and 137, which are facing downstream (towards right hand side of FIG. 4), and dimensioned to receive L-shaped ends 146 and 147 of stator vane segment 40. This means that, contrary to the embodiment shown in FIGS. 3A & 3B, engine case connecting element 135 prevents upstream axial movement (towards left hand side of FIGS. 3A & 3B) but allows downstream axial movement (towards right hand side of FIGS. 3A & 3B). Furthermore, in this embodiment, it is downstream axially adjacent elements of the gas turbine engine that will serve, to the level required, to limit the (downstream) freedom of movement. A further distinction with the embodiment shown in FIGS. 3A & 3B is that L-shaped ends 146, 147 and stator vane support element 148 extend from outer endwall 141, not from shroud segment 144. Shroud segment 144 extends axially therefrom. An abradable element 145 is secured to shroud segment 144. As stated above, it will be understood by those skilled in the art that other techniques, for radially securing each stator vane segment 40 to engine case 30 and for assisting in the structural integrity of stator vane segment 40 as it is secured to engine case 30, are possible pursuant to the invention.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A gas turbine engine apparatus comprising:
an engine case;
a circumferential array of rotor blades located within the engine case and rotatable about a centerline; and
a stator vane assembly located within the engine case, and axially spaced from the array of rotor blades, said stator vane assembly comprising a plurality of stator vane segments disposed circumferentially one adjacent to another, each stator vane segment comprising:
an outer endwall,
a plurality of vanes extending radially from the outer endwall towards the centerline, and
a shroud segment extending axially from the outer endwall configured to extend to and surround the array of rotor blades, the shroud segment including an abradable portion surrounding the rotor blades;
wherein the vane assembly is secured relative to the engine case.

2. The gas turbine engine apparatus, as defined in claim 1, wherein each stator vane segment is radially secured to the engine case.

3. The gas turbine engine apparatus, as defined in claim 1, wherein the shroud segment is positioned radially further away from the centerline than the outer endwall.

4. The gas turbine engine apparatus, as defined in claim 1, wherein the abradable element is positioned radially further away from the centerline than the outer endwall.

5. The gas turbine engine apparatus, as defined in claim 4, wherein the abradable element is positioned proximate to tips of the array of rotor blades.

6. The gas turbine engine apparatus, as defined in claim 1, wherein the outer endwall is positioned radially further closer to the centerline than tips of the array of rotor blades.

7. The gas turbine engine apparatus, as defined in claim 1, comprising a freedom of axial movement connection between the stator vane assembly and the engine case.

8. The gas turbine engine apparatus, as defined in claim 1, comprising coupling means allowing axial movement between the stator vane segment and the engine case.

9. The gas turbine engine apparatus, as defined in claim 1, wherein each pair of circumferentially adjacent stator vane segments defines an inter-segment gap, comprising a seal extending across such inter-segment gap.

10. The gas turbine engine apparatus, as defined in claim 9, wherein the seal is an axially-extending feather seal.

11. A method for sealing a rotating circumferential array of rotor blades in a gas turbine engine having an adjacent vane assembly, the method comprising:
surrounding the array of rotor blades with an abradable element assembly configured to abrade when contacted by the rotor blades;
securing the abradable element assembly to an outer shroud of the vane assembly; and
securing the vane assembly to the engine case.

12. The method as defined in claim 11, comprising segmenting the vane assembly into a plurality of vane segments.

13. The method as defined in claim 12, comprising securing each vane segment to the engine case.

14. The method as defined in claim 11, comprising allowing axial movement between the vane assembly and the engine case.

15. The method as defined in claim 13, comprising allowing axial movement between each vane segment and the engine case.

16. A stator vane segment for use in a gas turbine engine, the stator vane segment comprising a plurality of vanes extending between an outer endwall and an inner endwall, the outer endwall extending axially to provide a shroud, the shroud including an abradable portion configured to surround a rotating array of rotor blades; wherein the stator vane segment is configured to be securable to an engine case.

17. The stator vane segment as defined in claim 18, wherein the outer endwall is positioned closer to the inner endwall than the shroud segment.

18. The stator vane segment as defined in claim 18, wherein the outer endwall is positioned closer to the inner endwall than the abradable element.
